(19) United States
(12) Patent Application Publication
(10) Pub. No.: US 2008/0010015 A1
(43) Pub. Date: Jan. 10, 2008

(54) BUNDLE LOCATION SPECIFIED IN TERMS OF GPS COORDINATES

(76) Inventors: TIMOTHY P. LUKE, Austin, TX (US); RUKMINI RAO, Austin, TX (US)

Correspondence Address: Greg Goshorn, P.C., 9600 Escarpment, Suite 745-9, AUSTIN, TX, 78749, US

(21) Appl. No.: 11/428,994

(22) Filed: Jul. 6, 2006

(51) Int. Cl. G01C 21/00

(52) U.S. Cl. 701/213; 701/200

(57) ABSTRACT

Provided is a method for determining the actual physical location of a software application by integrating a software application, or bundle, with GPS technology. A software developer or provider creates a software bundle and defines geographical limits for the bundle. The bundle periodically queries a GPS locator associated with the computing system to determine the GPS coordinates of the computing system. If the system determines that the GPS coordinates are outside of the defined geographical limits for the bundle, the system disables the bundle. In addition, the software may be configured to transmit coordinates to a server in addition to or instead of disabling the application. The transmission of coordinates can be executed either periodically or only when a violation of the rental agreement is detected. A “GPS” bundle may be modular such that a GPS module can be included into any appropriate application to provide the claimed functionality.

### TECHNICAL FIELD

The present invention relates generally to computing systems and, more specifically, to a method for providing physical location tracking and control with respect to a software application or bundle.

### BACKGROUND OF THE INVENTION

With respect to computing techniques, in 1999, the OSGi® Alliance, herein after referred to simply as “OSGi,” was initiated to develop an open specification for the delivery of services over local networks and devices. Currently, the OSGi standard is supported by over eighty (80) companies. OSGi was developed to provide services to environments such as homes, cars and offices. Some embedded devices that employ the OSGi specification include, but are not limited to, television set top boxes, service gateways, cable modems, consumer electronic devices, personal computers (PCs), industrial computers and automobiles. A specification, entitled “The OSGi Services Platform, Release 3,” published in August 2004, provides support to mobile devices.

The OSGi environment is organized around a “framework” and “bundles.” The OSGi framework provides an execution environment for electronically downloadable services, or bundles. The framework includes a Java runtime engine, life cycle management, data storage, version management and a service registry. Bundles are the primary software components in the OSGi environment. They can contain Java classes and other resources, which provide libraries, services, and applications to end-users of a computing system and to other bundles. Typically, bundles are stored in a standard Zip-based Java file format, or Java Archive (JAR) file.

The global positioning system (GPS) was developed and is currently operated by the U.S. Department of Defense to provide users with geographical position data. GPS is implemented by twenty-four (24) satellites and corresponding receivers on the earth. Each satellite continuously transmits digital radio signals that contain data on the location of the satellite and the exact time to the earth-bound receiver. Based on how long it takes for signals from three (3) satellites to reach a receiver on earth, the receiver can calculate the longitude and latitude of the receiver. Using four (4) satellites, GPS can also determine altitude.

Currently, software applications, including those that employ OSGi technology, are referenced within a computing system by a name and location in the file system of the computing system. What is desirable and needed is the ability to reference an application by the actual physical location of the application. In other words, it would be useful to know that a particular application is, for example, located at 123 Main Street, Austin, Tex. rather than merely that the application is located on server XYZ. In addition, it would be desirable to be able to control an application or bundle based upon the application or bundle's location with respect a reference geographical location.

### SUMMARY OF THE INVENTION

Provided is a method for determining the actual physical location of a software application by integrating a software application, or bundle, with global positioning system (GPS) technology. A software developer or provider creates a software bundle and defines geographical limits for the bundle. The bundle, once installed on a computing system, periodically queries a GPS locator associated with the computing system to determine the GPS coordinates of the computing system. If the system of the disclosed technology determines that the GPS coordinates are outside of the defined geographical limits for the bundle, the system disables the bundle. For example, a developer may specify that a particular software application, installed in an automobile or truck, works only in the state of Texas. If a user drives the automobile or truck to New Mexico, the software would cease to function.

In addition, the software may be configured to transmit coordinates to a server in addition to or instead of disabling the application. For example, if the software is installed in a rental car and the driver enters New Mexico in violation of an agreement to use the car only in Texas, the software transmits coordinates to the rental agency and appropriate action may be taken. The transmission of coordinates can be executed either periodically or only when a violation of the rental agreement is detected.

A “GPS” bundle created in accordance with the claimed subject matter may be modular such that a GPS module programmed in accordance with the claimed subject matter can be included in any appropriate application to provide the claimed functionality. In this manner, the GPS functionality may be installed into legacy applications.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following drawings, in which:

FIG. 1 is a block diagram of a computing system that implements the claimed subject matter.

FIG. 2 is a block diagram an exemplary mobile device, i.e. an automobile, which implements the claimed subject matter.

FIG. 3 is a block diagram of an exemplary computing architecture that executes on the computing system and mobile device of FIGS. 1 and 2, respectively, and supports an OSGi framework and a bundle implemented in accordance with the claimed subject matter.

FIG. 4 is a flowchart of an exemplary Execute Module process that employs the claimed subject matter.

FIG. 5 is a flowchart of a Check Location process that implements the claimed subject matter.

### DETAILED DESCRIPTION OF THE FIGURES

Although described with particular reference to an OSGi framework, the claimed subject matter can be implemented in any information technology (IT) system in which a determination of the physical location of a software application is desirable. Those with skill in the computing arts will recognize that the disclosed embodiments have relevance to a wide variety of computing environments in addition to those described below. Further, although described with respect to bundles and application, the claimed subject matter also is applicable to modules, projects or any other type of interdependent computer logic. In other words, the disclosed technology is applicable to any situation in which there is interdependent computer code and a user or developer needs or wants to track and/or control the physical location of the code.

In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for physical location determination of a software application. The term “programmed method”, as used herein, is defined to mean one or more process steps that are presently performed; or, alternatively, one or more process steps that are enabled to be performed at a future point in time. The term programmed method anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

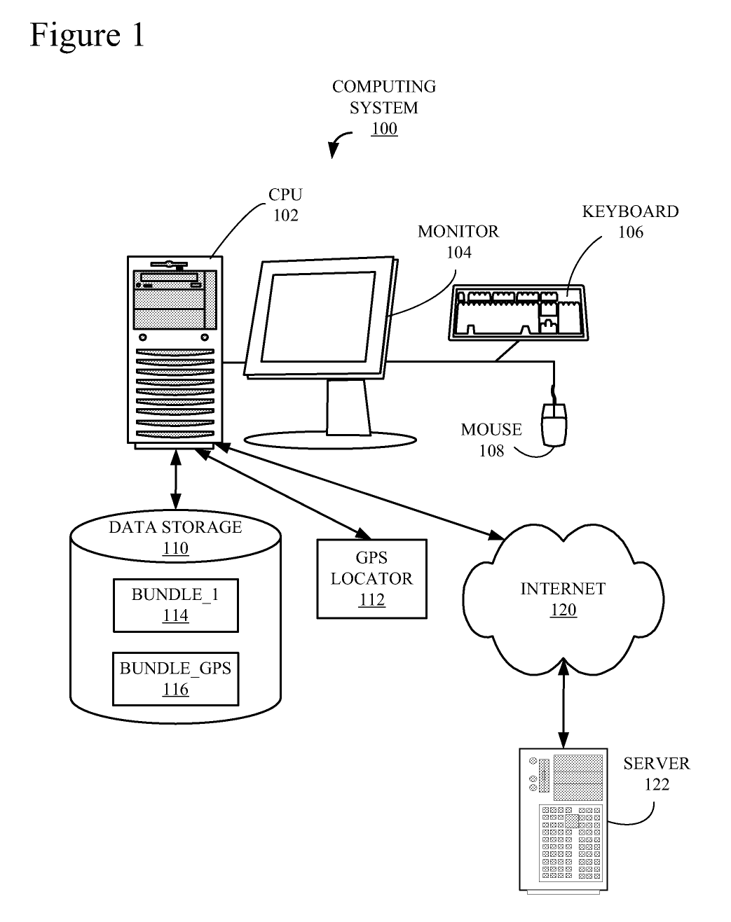

Turning now to the figures, FIG. 1 is a block diagram of an exemplary computing system architecture 100 that incorporates the claimed subject matter. A central processing unit (CPU) 102 is coupled to a monitor 104, a keyboard 106 and a mouse 108, which together facilitate human interaction with computing system 100. Attached to CPU 102 is a data storage component 110, which may either be incorporated into CPU 102 i.e. an internal device, or attached externally to CPU 102 by means of various, commonly available connection devices such as but not limited to, a universal serial bus (USB) port (not shown). Computing system 100 also includes a GPS locator 112 that is employed to implement the claimed subject matter. GPS locators such as locator 112 should be familiar to those with skill in the computing arts.

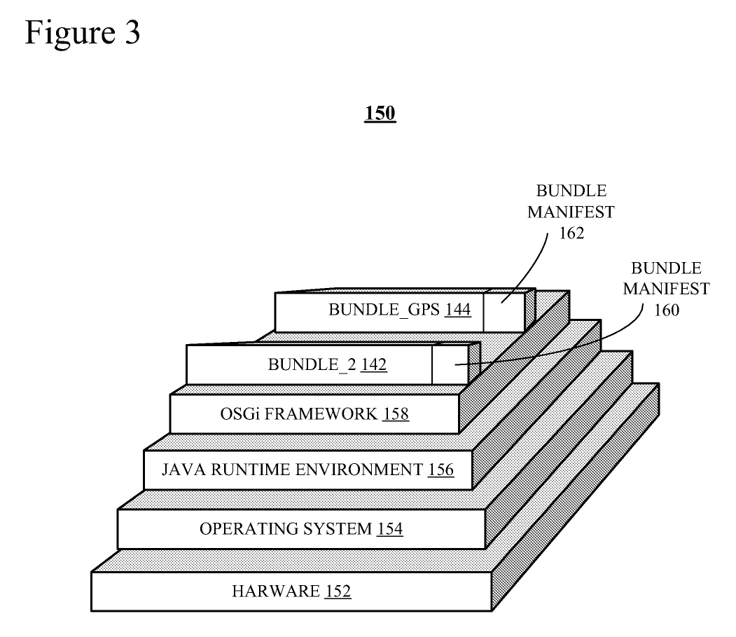

Data storage 110 is illustrated storing several exemplary OSGi bundles, including a first bundle, or “bundle_{—}1,” 114 and a second bundle, or “bundle_GPS,” 116. Bundle_1 114 is a typical OSGi bundle that is used for illustrative purposes. It should be noted that a typical application or system may include many OSGi bundles, but for the sake of simplicity only two are shown. Bundle_GPS 116 is an object that implements the functionality associated with the claimed subject matter. Bundle_GPS 116 is described in more detail below in conjunction with FIGS. 3-5.

CPU 102 is connected to the Internet 120, which is also connected to a server computer 122. Although in this example, CPU 102 and server 122 are communicatively coupled via the Internet, they could also be coupled through any number of communication mediums such as, but not limited to, a local area network (LAN) (not shown).

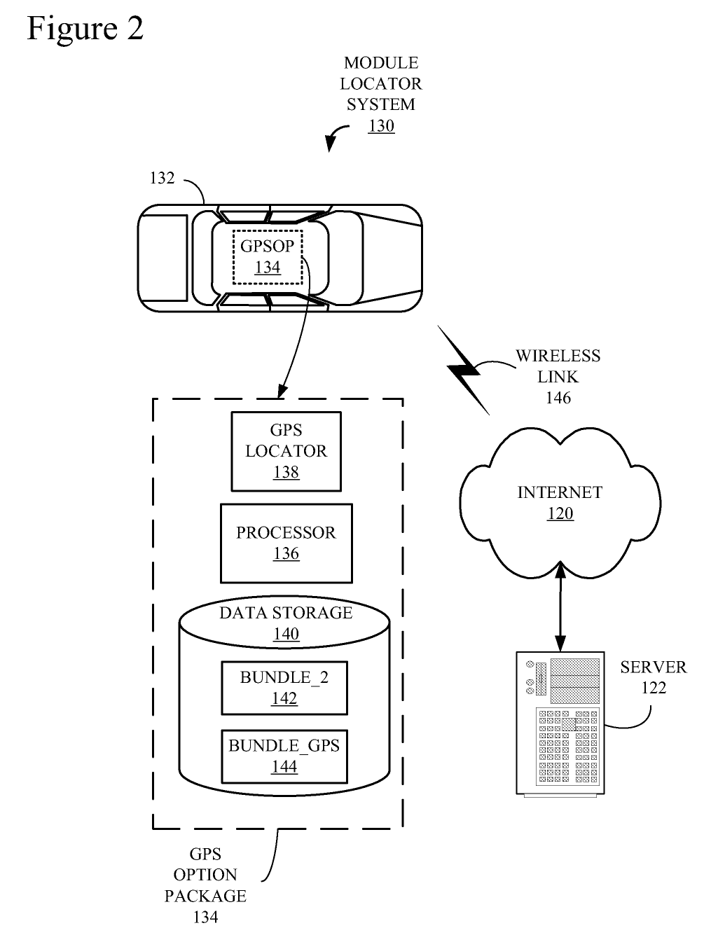

FIG. 2 is a block diagram of an exemplary module locator system (MLS) 130 that implements the claimed subject matter. MLS 130 is illustrated with respect to an automobile 132 and is executed by a GPS option package (GPSOP) 134, which is also shown in FIG. 2 in an expanded form. Although shown with respect to an automobile, the claimed subject matter can be implemented in any system in which the physical location may be an issue and the necessary computing capabilities are present. For example, other systems may include, but are not limited to, trucks, trains, airplanes and any mobile computing devices such as laptop computers, table computers and personal digital assistants (PDAs).

GPSOP 134 includes a processor 136, a GPS locator 138 and data storage 140. Data storage 140 is illustrated storing a bundle_2 142 and a bundle_GPS 144 that stores the logic for implementing the claimed subject matter. Although illustrated as part of GPSOP 134, processor 136, GPS locator 138, and data storage 140 may be installed on automobile 132 and used for other conventional applications. In other words, GPSOS 134 may be implemented with respect to bundle_2 142 by bundle_GPS 144 on a conventional system that includes devices 136, 138 and 140.

MLS 130 is able to communicate via a wireless link 146 to the Internet 120 (FIG. 1) and server 122 (FIG. 1). Of course, Internet 120 is only one example of communication media that may be employed by a communication link such as link 146. Other examples include, but are not limited to, a cellular network, a satellite communication network and a Wi-Fi network. Those with skill in the computing and/or communication arts should appreciate the many ways a mobile device might be able to communicate with another device such as server 122. For the rest of the Specification, MLS 130 is employed as an example of one implementation the claimed subject matter. The disclosed techniques apply to any mobile computing scenario in which location is a factor.

FIG. 3 illustrates an exemplary computing architecture 150 that supports an OSGi framework 158 and the claimed subject matter. System 150 is implemented on a hardware platform 152, in this example, GPSOP 134 (FIG. 2). An operating system (OS) 154 manages the resources of GPSOP 134. Examples of three OSs that support the claimed subject matter include Linux, MacIntosh and the various versions of Windows, all of which, as well as others, should be familiar to those with skill in the computing arts. In this example, OS 154 is supporting a Java runtime environment 156. Java runtime environment 156 supports the Java programming language, which is a product of Sun Microsystems, Inc. of Santa Clara, Calif. Java runtime environment 156 includes a Java runtime engine (not shown) which executes Java programs, Java programs are compiled into byte codes which are interpreted by the Java runtime environment 156 rather then being compiled into native machine code. In this manner, a particular Java program can be written to execute on any hardware platform, such as CPU 102 (FIG. 1) and GPSOP 134, and operating system, such as OS 154, that includes the Java runtime environment 156.

OSGi framework 158 is designed to operate in Java runtime environment 156. Framework 158 provides the core of the OSGi Service Platform Specification. As explained above in the Background, the OSGi Service Platform Specification was first developed in 1999 to simplify the delivery of services over local networks and devices, industrial computers and automobiles. OSGi framework 158 provides an execution environment for, in this example, electronically downloadable services, or bundle_2 142 (FIG. 2) and bundle_GPS 144 (FIG. 2). Framework 158 includes program life cycle management, data storage, program version management and a service registry for bundles 142 and 144. In this example, bundles 142 and 144 are part of a single Java application or service and include classes, methods and other resources, which provide functions, or “services,” to GPSOP 134 and other bundles. Typically, but not necessarily, bundles 142 and 144 are stored in a standard Zip-based Java file format, or Java Archive (JAR) file. Bundle_GPS 144, implements aspects of the claimed subject matter by providing a location processing “shell” for bundle_2 142.

As mentioned above, OSGi bundles 142 and 144 include Java classes and other resources (not shown) which provide functions to end users of GPSOP 134 and provide components, or “services,” to other bundles. Bundles typically implement zero or more services. Bundles 142 and 144 may include such things as, but not limited to, class files for the Java programming language as well as other data. Like other OSGI compliant bundles, bundles 142 and 144 each include a manifest file 160 and 162, respectively, which describes the contents of the corresponding bundle 142 or 144 and provides information that framework 158 requires to correctly install and activate the corresponding bundle 142 and 144. Bundles 142 and 144 also include a special class, or “bundle activator,” (not shown) that provides methods to start and stop the bundle 142 and 144. In addition, bundles 142 and 144 include, in manifest files 160 and 162, respectively, information about any resource dependencies the corresponding bundle 142 or 144 may have.

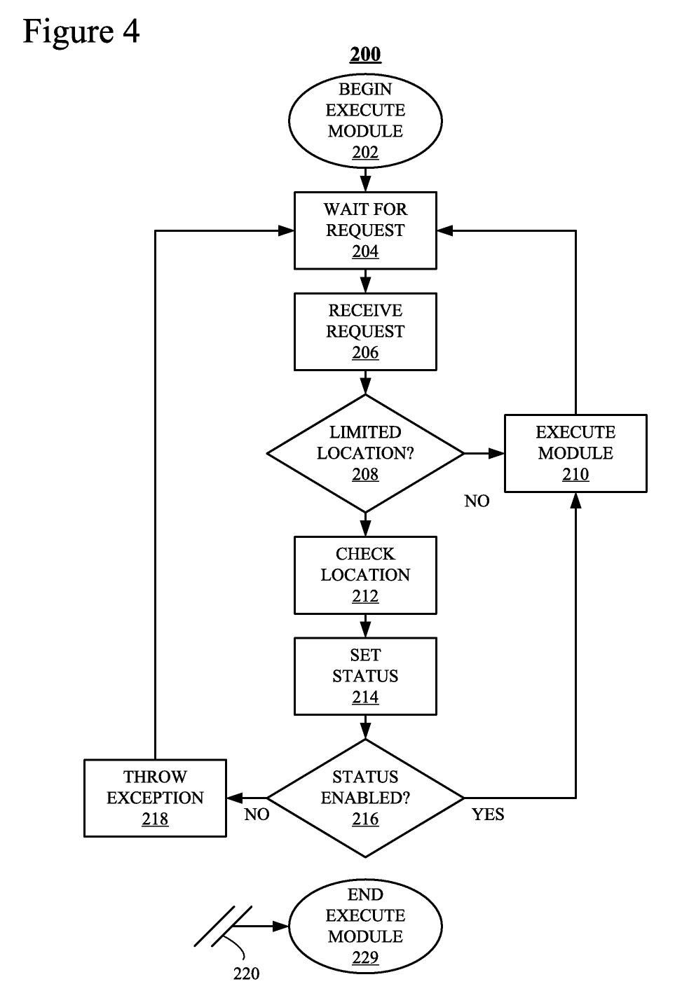

FIG. 4 is a flowchart of an exemplary Execute Module process 200 that employs the claimed subject matter. In this example, process 200 is implemented as part of bundle_GPS 144 (FIGS. 2 and 3), which as explained above is stored on data storage 140 (FIG. 2) and executed on processor 136 (FIG. 2). Process 200 is executed whenever a module, such as bundle_2 (FIGS. 2 and 3), that is managed by GPSOP 134 (FIG. 2) is initiated.

Process 200 starts in a “Begin Execute Module” block 202 and proceeds immediately to a “Wait for Request” block 204, During block 204, process 200 is on standby and waiting for a signal indicating that a module, in this example module_2 142 has been initiated. Once such a signal is received in a “Receive Request” block 206, process 200 proceeds to a “Limited Location?” block 208 during which process 200 determines whether or not the execution request signal received during block 206 corresponds to a module subject to the limits imposed by the claimed subject matter. If not, process 200 proceeds to an “Execute Module” block 210 during which the module corresponding to the signal received during block 206 is executed. Process 200 then returns to Wait for Request block 204 and processing continues as described above.

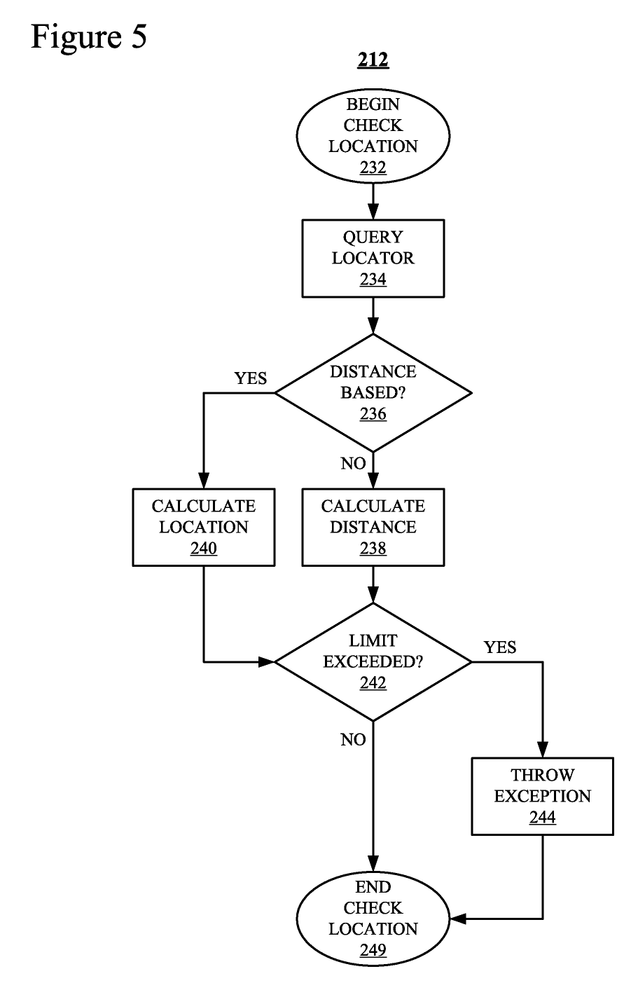

If, during block 208, process 200 determines that the module corresponding to the signal received during block 206 is subject to the location limitations according to the claimed subject matter, process 200 proceeds to a “Check Location” block 212, Block 212 is described in more detail below in conjunction with FIG. 5. Once the location has been checked during block 212, a status variable (not shown) is set during a “Set Status” block 214. For example, if block 212 returns an exception, indicating that the location check determined that the module is located outside of acceptable parameters, the status variable would be set to a value of “disabled.” If block 212 determines that the module is within parameters, the status variable is set to a value of “enabled.” corresponding to the results of the processing of block 212.

Process 200 then proceeds to a “Status Enabled?” block 216. During block 214, process 200 determines whether or not the status variable is set to a value of “enabled” or “disabled.” If the value equals “enabled,” process 200 proceeds to Execute Module block 210 and processing continues as described above. If the value equals “disabled,” process 200 proceeds to a Throw Exception block 218. During block 218, process 200 performs whatever action GPSOP 134 has been configured to execute in such a circumstance. Examples of appropriate action include, but are not limited to, transmitting a notice to the driver or owner of automobile 132, information stored in a log file (not shown) on data storage 140 and/or the disabling of functionality associated with the module whose execution caused the exception to be thrown. Of course location data may be transmitted to an owner or other interested party whenever a module is executed or periodically during execution so the owner can establish a record of a particular bundle's geographical location. In another embodiment, the action associated with a thrown exception could be executed during a “Throw Exception” block 244 (see FIG. 5) executed in conjunction with block 212 rather than returned to process 200 for action.

Once appropriate action has been taken with respect to Throw Exception block 218, process 200 returns to block 204 and processing continues as described above. It should be noted that process 200 is configured to run continuously. An asynchronous interrupt 220 is executed to halt processing. Interrupt may be executed, for example, when GPSOP 134 is powered down or in response to a thrown interrupt. Once asynchronous interrupt 218 is detected, process 200 proceeds to an “End Execute Module” block 229 in which process 200 is complete.

FIG. 5 is a flowchart of Check Location block, or process, 212, which implements one embodiment of the claimed subject matter and is first introduced above in conjunction with FIG. 4. The following example is described with respect to a system implemented in conjunction with automobile 132 of FIG. 2 and called due to the execution of a bundle (not shown) associated with the claimed subject matter. A bundle associated with the claimed subject matter would incorporate bundle_GPS 142 (FIG. 2), which actually implements the claimed subject matter.

Process 212 starts in a “Begin Check Location” block 232 and proceeds immediately to a “Query Locator” block 234. During block 234, process 212 retrieves information corresponding to the location of GPSOP 134 (FIG. 2) and modules 142 and 144 (FIGS. 2 and 3) from GPS locator 138 (FIG. 2). During a “Distance Based?” block 236, process 212 determines whether the bundle associated with this instantiation of bundle_GPS 142 is regulated based upon the specific location of automobile 132 or the distance of automobile 132 from a particular location. It should be noted the two criteria described, location and distance, are used merely as examples. Other criteria may also be valid, such as a combination of location and criteria.

If, during block 236, process 212 determines that the criteria is distance based, process 212 proceeds to a “Calculate Distance” block 238 during which process 212 determines, based upon the location information received during block 234 the distance of automobile 132 from the relevant reference location. If, during block 236, process 212 determines that the criteria is location based, process 212 proceeds to a “Calculate Location” block 240 during which process 212 calculates the exact location of automobile 132 based upon the location information received during block 234.

During a “Limit Exceeded?” block 242, process 212 determines whether or not automobile 132 is within acceptable boundaries, whether distance based as determined during block 238 or location based as determined during block 240. Typically, a distance based calculation would be based upon a comparison of a distance figure calculated during block 238 with the difference between a stored, acceptable-distance parameter (not shown) and the coordinates of a particular geographical location, both stored on data storage 140 (FIG. 2). A location based determination would be based upon a comparison of the location information received during block 234 with a table of acceptable geographical boundary location information stored on data storage 140.

If process 212 determines during block 242 that the location of automobile 132 is outside of acceptable parameters, process 212 proceeds to a “Throw Exception” block 244. As explained above in conjunction with FIG. 4, a throw exception may either be resolved during block 244 of process 212 or passed to the calling process, which in this example is process 200, for resolution, depending upon the particular configuration of GPSOP 134. If process 212 determines during block 242 that location limits have not been exceeded, or after an exception has been thrown during block 244, process proceeds to an “End Check Location” block 249 in which process 212 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for controlling a software module, comprising:
defining a computer software application bundle;
defining geographical parameters corresponding to the bundle;
retrieving from a global positioning satellite (GPS) system geographical location information corresponding to the bundle;
comparing the defined geographical parameters and the geographical location information;
setting a status of the bundle based upon the comparison of the geographical parameters and the geographical location information; and
controlling the bundle based upon the value of the status.

2. The method of claim 1, further comprising setting the status to disabled when the comparing reveals that a location corresponding to the geographical location information is outside of a boundary corresponding to the geographical parameters.

3. The method of claim 1, further comprising setting the status to enabled when the comparing reveals that a location corresponding to the geographical location information is inside of a boundary corresponding to the geographical parameters.

4. The method of claim 1, wherein the geographical parameters define a plurality of geographical areas.

5. The method of claim 1, wherein the geographical parameters define a particular geographical location and a maximum distance from the particular geographical location.

6. The method of claim 1, wherein the bundle is an OSGi package.

7. The method of claim 1, further comprising transmitting a message when the comparing reveals that a location corresponding to the geographical is outside of a boundary corresponding to the geographical parameters.

8. A system for controlling a software module, comprising:
a computer software application bundle;
geographical parameters corresponding to the bundle;
logic for querying a global positioning satellite (GPS) system to retrieve geographical location information corresponding to the bundle;
logic for comparing the geographical parameters and the geographical location information;
logic for setting a status corresponding to the bundle based upon the comparing of the geographical parameters and the geographical location information; and
logic for controlling the bundle based upon the value of the status.

9. The system of claim 8, further comprising setting the status to a value of disabled when the logic for comparing reveals that a location corresponding to the geographical location information is outside of a boundary corresponding to the geographical parameters.

10. The system of claim 8, further comprising setting the status to a value of enabled when the logic for comparing reveals that a location corresponding to the geographical location information is inside of a boundary corresponding to the geographical parameters.

11. The system of claim 8, wherein the geographical parameters define a plurality of geographical areas.

12. The system of claim 8, wherein the geographical parameters define a particular geographical location and a maximum distance from the particular geographical location.

13. The system of claim 8, wherein the bundle is an OSGi package.

14. The system of claim 8, further comprising transmitting a message when the logic for comparing reveals that a location corresponding to the geographical location information is outside of a boundary determined by the geographical parameters

15. A computer programming product for controlling a software module, comprising:
a memory;
a computer software application bundle, stored on the memory;
geographical parameters corresponding to the bundle, stored on the memory;
logic, stored on the memory, for retrieving from a global positioning satellite (GPS) system geographical location information corresponding to the bundle;
logic, stored on the memory, for comparing the defined geographical parameters and the geographical location information; and
logic, stored on the memory, for setting a status of the bundle based upon the comparison of the geographical parameters and the geographical location information.

16. The computer programming product of claim 15, further comprising logic, stored on the memory, for disabling the bundle when the comparing reveals that a location corresponding to the geographical location information is outside of a boundary corresponding to the geographical parameters.

17. The computer programming product of claim 15, further comprising logic, stored on the memory, for enabling the bundle when the comparing reveals that a location corresponding to the geographical location information is inside of a boundary corresponding to the geographical parameters.

18. The computer programming product of claim 15, wherein the geographical parameters define a plurality of geographical areas.

19. The computer programming product of claim 15, wherein the geographical parameters define a particular geographical location and a maximum distance from the particular geographical location.

20. The computer programming product of claim 15, further comprising logic, stored on the memory, for transmitting a message when the comparing reveals that a location corresponding to the geographical is outside of a boundary corresponding to the geographical parameters.
